(19) United States
(12) Patent Application Publication
(10) Pub. No.: US 2011/0149819 A1
(43) Pub. Date: Jun. 23, 2011

(54) APPARATUS AND METHOD FOR SYNCHRONIZING USB COMMUNICATION IN USB-WIRELESS LAN SYSTEM

(75) Inventor: Haeyoung RHA, Daejeon (KR)

(73) Assignee: Electronics and Telecommunications Research Institute, Daejeon (KR)

(21) Appl. No.: 12/965,780

(22) Filed: Dec. 10, 2010

(30) Foreign Application Priority Data
Dec. 21, 2009 (KR) 10-2009-0128513

(51) Int. Cl. H04W 52/02

(52) U.S. Cl. 370/311

(57) ABSTRACT

An apparatus for synchronizing with a USB host by a mobile node having a USB device in a USB-wireless LAN system while reducing power consumption includes: a power mode controller configured to control the power mode of the mobile node; a USB device configured to receive data from the USB host and transmit an ACK or a NAK to the USB host based on the power mode; and a wireless LAN transmitter configured to transmit data received by the USB device according to wireless LAN specifications.

### CROSS-REFERENCE TO RELATED APPLICATIONS

The present application claims priority of Korean Patent Application No. 10-2009-0128513, filed on Dec. 21, 2009, which is incorporated herein by reference in its entirety.

### BACKGROUND OF THE INVENTION

1. Field of the Invention

Exemplary embodiments of the present invention relate to an apparatus and a method for synchronizing USB communication in a wireless LAN system having a USB as a host interface; and, more particularly, to an apparatus and a method for minimizing power consumption by synchronizing USB communication in a wireless LAN system having a USB as a host interface.

2. Description of Related Art

In the case of conventional USB-based transmission, the corresponding terminal buffer can receive USB data regardless of the operating mode of the wireless LAN system and, if space large enough to store data to be transmitted is secured, the transmitted data is received and stored. If there is stored data, the wireless LAN transmission block changes the operating mode from a doze mode to an active mode, in order to transmit the corresponding data, and transmits wireless LAN packets.

FIG. 1 illustrates the construction of a wireless LAN system having a USB as a host interface.

Referring to FIG. 1, the system includes a USB host 110, a wireless LAN system 120 including a USB device 121 configured to communicate with the USB host 110, and an AP (Access Point) 130 configured to communicate with the wireless LAN system 120. The wireless LAN system 120 includes a USB device 121 configured to support USB interface with the USB host 110, a packet transmit path 123 configured to transfer data, which has been received through the USB, to a WLAN TX (wireless LAN transmitter) 125, a packet receive path 124 configured to transfer data, which has been received through a WLAN RX (wireless LAN receiver), to the USB host 110 through the USB device 121, a WLAN TX 125 and a WLAN RX 126 configured to transmit/receive packets with another wireless LAN system, specifically the AP 130 in the case of FIG. 1, and a power mode controller 122 configured to determine the power mode of the wireless LAN.

FIG. 2 illustrates the construction of transmit operations of a wireless LAN system having a USB as a host interface.

Referring to FIG. 2, the system includes a base station, e.g. AP 210 configured to periodically transmit beacon signals 211 and 212, a mobile node 220 configured to switch between a doze mode and an active mode according to a power save protocol, a USB host 230, a USB device 240 included in the mobile node 220 and configured to communicate with the USB host, and a packet transmit path 250 within the mobile node 220. It will be assumed in the following description of the wireless LAN system that the base station is an AP.

The transmit operation of the wireless LAN system, which has a USB as a host interface, will now be described with reference to FIG. 2. The AP 210 periodically transmits beacon signals 211 and 212 to the mobile node 220, at step S201 and S202. The mobile node 220 of the 802.11 wireless LAN system, which adopts a power save protocol, switches from the doze mode to the active mode 221 and 223 in order to receive the beacon signals 211 and 212. The mobile node 220 determines, based on information acquired from the beacon signals 211 and 212, whether to switch to the doze mode 222 and 224, or to remain in the active mode 221 and 223 and to wait for packets to be received or transmit.

If the USB host 230 sends data 230 at step S203, which is to be transmitted through the wireless LAN, to the USB device 240 while the mobile node 220 is in the doze mode 225, the USB device 240 transmits an ACK 241 to the USB host 230 at step S204 in response to the successfully transmitted data. In this case, the mobile node 220 considers that there is data to be transmitted wirelessly, and switches from the doze mode 225 to the active mode 226. Then, at step S205, the WLAN TX of the mobile node wirelessly transmits a packet 251, which has been received from the USB device 240 through the packet transmit path 250, to the AP 210 or another mobile node through the wireless LAN.

This type of operation has a problem in that, when there exists data to be transmitted, continuous mode change increases power consumption of the mobile node.

### SUMMARY OF THE INVENTION

An embodiment of the present invention is directed to an apparatus and a method for synchronization capable of reducing power consumption of the mobile node.

Another embodiment of the present invention is directed to an apparatus and a method for synchronization capable of efficient packet transmission.

Another embodiment of the present invention is directed to an apparatus and a method for synchronization capable of maintaining compatibility between a USB system and a wireless LAN system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for synchronizing with a USB host by a mobile node having a USB device in a USB-wireless LAN system while reducing power consumption includes: a power mode controller configured to control the power mode of the mobile node; a USB device configured to receive data from the USB host and transmit an ACK or a NAK to the USB host based on the power mode; and a wireless LAN transmitter configured to transmit data received by the USB device according to wireless LAN specifications.

In accordance with another embodiment of the present invention, a method for synchronizing with a USB host by a mobile node having a USB device in a USB-wireless LAN system while reducing power consumption includes: receiving data to be transmitted through a wireless LAN from the USB host; determining a mode condition of the mobile node; and transmitting a NAK indicating that the data cannot be received to the USB host when the mode is a doze mode.

In accordance with another embodiment of the present invention, a method for synchronizing with a mobile node having a USB device by a USB host in a USB-wireless LAN system includes: receiving information regarding the mode of the mobile node from the USB device; determining the mode of the mobile node based on the information regarding the mode of the mobile node; and buffering, by the USB host, data to be transmitted through the wireless LAN when the mode of the mobile node is a doze mode.

### BRIEF DESCRIPTION OF THE DRAWINGS

FIG. 1 illustrates the construction of a wireless LAN system having a USB as a host interface.

FIG. 2 illustrates the construction of transmit operations of a wireless LAN system having a USB as a host interface.

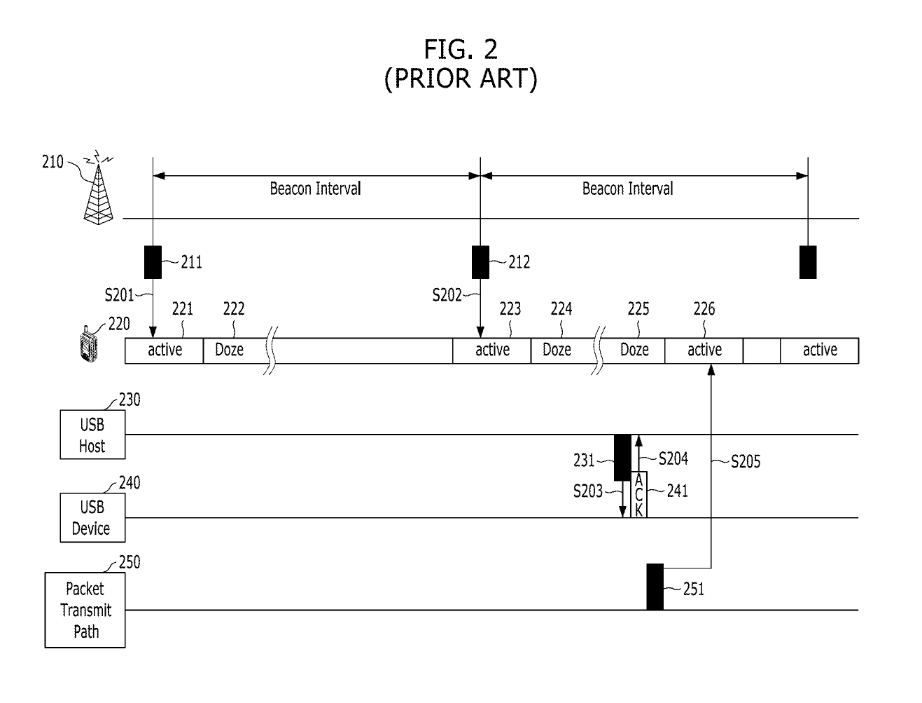

FIG. 3 illustrates the construction for transmit operation of a wireless LAN system having a USB as a host interface in accordance with an embodiment of the present invention.

FIG. 4 is a flowchart illustrating the operation of a USB-wireless LAN system, which is in a power save condition, in accordance with an embodiment of the present invention.

FIG. 5 is a flowchart illustrating the operation of a USB-wireless LAN system, which is in a power save condition, in accordance with another embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention is directed to a method and an apparatus for minimizing standby power consumption through synchronization in a wireless LAN system having a USB as a host. In order to minimize standby power, it is necessary to minimize function blocks, which function in the doze mode, among function blocks constituting a USB-wireless LAN system. Specifically, it is proposed that in order to minimize power consumption, minimum function blocks for responding to USB transmission in the doze mode are solely allowed to operate, while remaining blocks are not used. To this end, a method and a system for synchronizing communication with the USB according to the operating mode of the wireless LAN will be disclosed. As used herein, the USB-wireless LAN system refers to a network structure which uses a USB as the host, which includes a mobile node having a USB device configured to communicate with the USB host, and which has a BSS (Basic Service Set) as the basic unit, where the mobile node coexists with a base station configured to communication with the mobile node.

An exemplary embodiment of the present invention will now be described in detail with reference to the accompanying drawings.

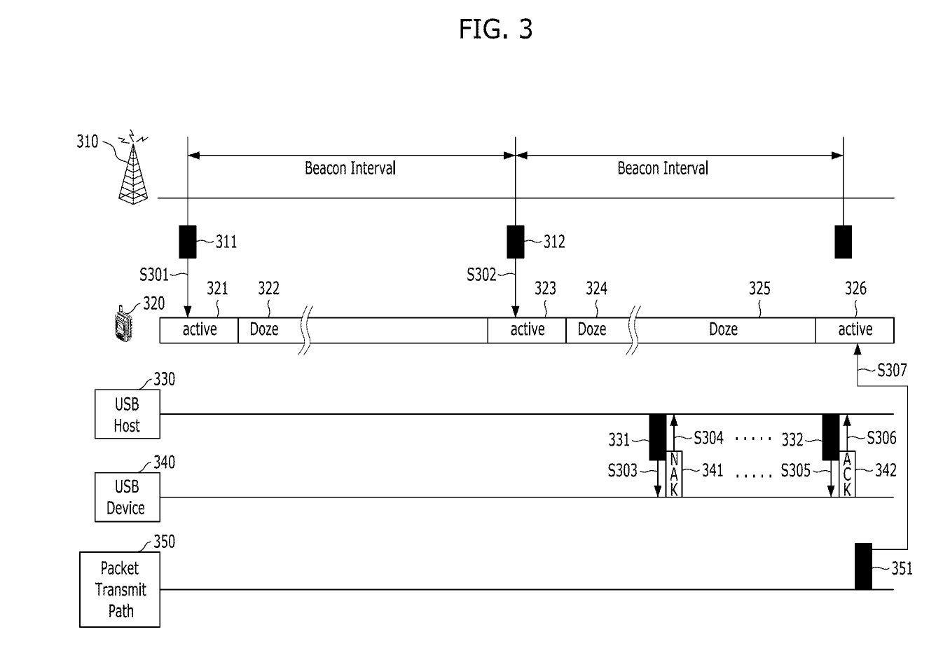

FIG. 3 illustrates the construction for transmit operation of a wireless LAN system having a USB as a host interface in accordance with an embodiment of the present invention.

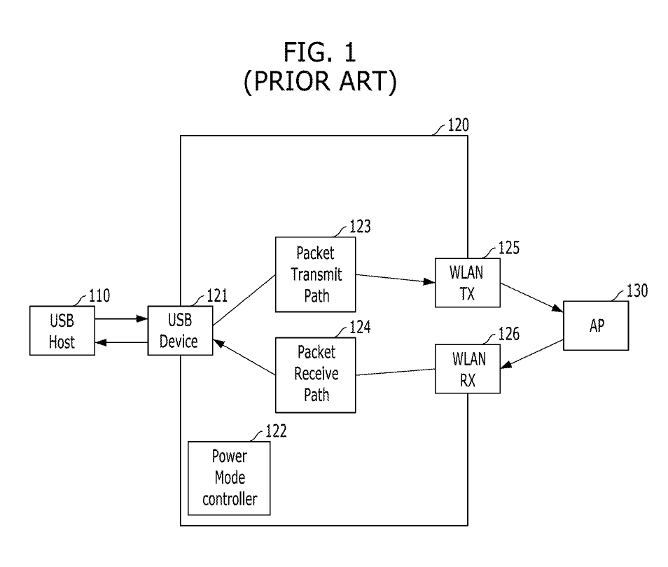

Referring to FIG. 3, the system includes a base station, e.g. AP 310 configured to periodically transmit beacon signals 311 and 312, a mobile node 320 configured to switch between a doze mode and an active mode according to a power save protocol, a USB host 330, a USB device 340 included in the mobile node 320 and configured to communicate with the USB host, and a packet transmit path 350 within the mobile node 320. It will be assumed in the following description of the wireless LAN system that the base station is an AP. The mobile node 320 includes a power mode controller (not shown in FIG. 3) configured to determine the power mode. The remaining construction of the mobile node of FIG. 3 is the same as that of FIG. 1.

The transmit operation of a wireless LAN system having a USB as the host interface in accordance with an embodiment of the present invention will now be described with reference to FIG. 3. The AP 310 periodically transmits beacon signals 311 and 312 to the mobile node 320, at step S301 and S302. The mobile node 320 of the 802.11 wireless LAN system, which adopts a power save protocol, switches from the doze mode to the active mode 321 and 323 in order to receive the beacon signals 311 and 312. The mobile node 320 determines, based on information acquired from the beacon signals 311 and 312, whether to switch to the doze mode 322 and 324, or to remain in the active mode 321 and 323 and to wait for packets to be received or transmit. Such mode switching information and change are controlled by the power mode controller of FIG. 1.

If the USB host 330 sends data 331 at step S303, which is to be transmitted through the wireless LAN, while the mobile node 320 is in the doze mode 325, the USB device 340 transmits an NAK 341 to the USB host 330 at step S304 in response to the transmitted data. This is for the purpose of preventing the mode from being changed by packets, i.e. data 331 transmitted by the USB host 330, and thus reducing unnecessary power consumption. After receiving the NAK 341, the USB host 330 continuously transmits packets, i.e. data 332 to the USB device 340 at step S305 until data 332 is successfully transmitted. If the mobile node 320 switches from the doze mode 325 to the active mode 326, at step S306, the USB device 340 transmits an ACK 342 regarding data 332 received from the USB host 330 so that the USB host 330 is informed of successful transmission. Then, at step S307, the WLAN TX of the mobile node 320 wirelessly transmits a packet 351, which has been received from the USB device 340 through the packet transmit path 350, to the AP 210 or another mobile node through the wireless LAN.

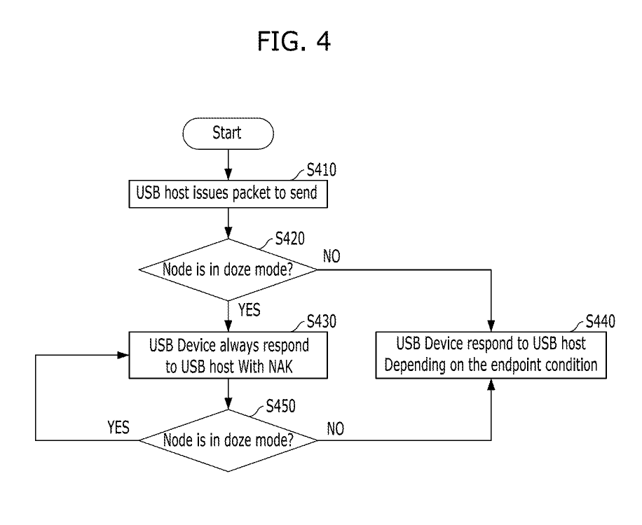

FIG. 4 is a flowchart illustrating the operation of a USB-wireless LAN system, which is in a power save condition, in accordance with an embodiment of the present invention.

The USB device 340 receives a packet from the USB host 330 at step S410. The mode of the mobile node 320 is determined at step S420. When it is determined that the mobile node 320 is a doze mode 325, the USB device 340 always transmits a NAK 341 to the USB host 330 at step S430. When it is determined that the mobile node 320 is not in a doze mode, i.e. when it is in an active mode 326, the USB device 340 transmits an ACK 342 to the USB host 330 depending on the endpoint condition at step S440. When the mobile node 320 is continuously in the doze mode 325, the USB device 340 always responds with a NAK 341 at step S450. When the mobile node 320 is not in the doze mode, i.e. when it is in the active mode 326, the USB device 340 transmits an ACK 342 to the USB host 330 depending on the endpoint condition. The above-mentioned mobile node is a part of the USB-wireless LAN system, and the mode change of the mobile node is the same as the condition change of the USB-wireless LAN system.

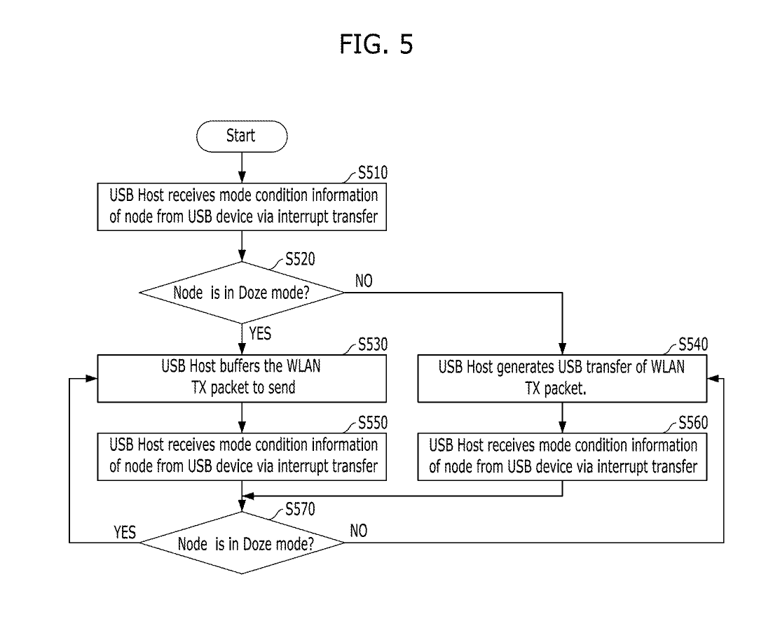

FIG. 5 is a flowchart illustrating the operation of a USB-wireless LAN system, which is in a power save condition, in accordance with another embodiment of the present invention.

The USB host 330 receives information regarding the mode of the mobile node 320 through an interrupt transfer message from the USB device 340 at step S510. The USB host 330 determines at step S520 whether the mobile node 320 is in a doze mode or in an active mode based on the interrupt transfer message, which has been received at the step S510. When it is determined that the mobile node 320 is in a doze mode, the USB host 330 does not transmit a packet, which is to be transmitted through the wireless LAN, but buffers the packet at step S530. When it is determined that the mobile node 320 is not in the doze mode, i.e. when it is in the active mode, the USB host 330 generates a packet, which is to be transferred through the wireless LAN, and transmits the packet to the USB device 340 at step S540. The USB host 330 receives the mode condition of the mobile node 320 at steps S550 and S560. The mode condition, as used herein, refers to either a doze condition or an active condition, and the steps S550 and S560 may be omitted if there is no mode change. That is, when either the doze condition or the active condition persists, the USB device 340 does not transfer information regarding the mode of the mobile node. It is only when the mode is changed that the USB device 340 transmits information regarding the mode of the mobile node to the USB host 330. This avoids transmission of any unnecessary message. The USB host 330 determines at step S570 whether the mobile node 320 is in the doze mode or in the active mode. When it is determined that the mobile node 320 is in the doze mode, the USB host 330 returns to the step S530 and buffers the packet. When it is determined that the mobile node 320 is not in the doze mode, i.e. when it is in the active mode, the USB host 330 returns to the step S540 and generates and transmits a packet.

In accordance with the exemplary embodiments of the present invention, the method and system for synchronization can reduce power consumption of the mobile node, transmit packets efficiently, and maintain compatibility between a USB system and a wireless LAN system.

While the present invention has been described with respect to the specific embodiments, it will be apparent to those skilled in the art that various changes and modifications may be made without departing from the spirit and scope of the invention as defined in the following claims.

What is claimed is:

1. An apparatus for synchronizing with a USB host by a mobile node having a USB device in a USB-wireless LAN system while reducing power consumption, comprising:
a power mode controller configured to control the power mode of the mobile node;
a USB device configured to receive data from the USB host and transmit an ACK or a NAK to the USB host based on the power mode; and
a wireless LAN transmitter configured to transmit data received by the USB device according to wireless LAN specifications.

2. The apparatus of claim 1, further comprising a USB host configured to transmit data to the USB device and receive the ACK or the NAK as a response to the transmitted data.

3. The apparatus of claim 1, further comprising a base station configured to transmit/receive the data with the mobile node according to the wireless LAN specifications.

4. The apparatus of claim 1, wherein the ACK indicates that, when the mobile node is in an active mode, the data is successfully received.

5. The apparatus of claim 1, wherein the NAK indicates that, when the mobile node is in a doze mode, the data cannot be received.

6. A method for synchronizing with a USB host by a mobile node having a USB device in a USB-wireless LAN system while reducing power consumption, comprising:
receiving data to be transmitted through a wireless LAN from the USB host;
determining a mode condition of the mobile node; and
transmitting a NAK indicating that the data cannot be received to the USB host when the mode is a doze mode.

7. The method of claim 6, further comprising:
transmitting an ACK or a NAK according to the condition of the mobile node when the mode is an active mode.

8. The method of claim 6, wherein the ACK informs the USB host that the transmitted data has been successfully transmitted.

9. The method of claim 6, wherein the NAK informs the USB host that the transmitted data has not been successfully transmitted.

10. A method for synchronizing with a mobile node having a USB device by a USB host in a USB-wireless LAN system, comprising:
receiving information regarding the mode of the mobile node from the USB device;
determining the mode of the mobile node based on the information regarding the mode of the mobile node; and
buffering, by the USB host, data to be transmitted through the wireless LAN when the mode of the mobile node is a doze mode.

11. The method of claim 10, further comprising:
generating data to be transmitted through the wireless LAN, when the mode of the mobile node is an active mode, and transmitting the generated data to the USB device.

12. The method of claim 10, wherein, when the mode of the mobile node is changed, the USB host is informed of the mode change of the mobile node by the USB device.

13. The method of claim 10, wherein, when the doze mode of the mobile node is not changed, packets are buffered continuously.

14. The method of claim 11, wherein, when the active mode of the mobile node is not changed, packets are continuously generated and transmitted to the USB device.
